(19) United States
(12) Patent Application Publication
(10) Pub. No.: US 2023/0316895 A1
(43) Pub. Date: Oct. 5, 2023

(54) FIREARM MONITORING SYSTEMS AND METHODS

(71) Applicant: Kudzu Arms, LLC, Hogansville, GA (US)

(72) Inventor: Christopher G. Bailey, Hogansville, GA (US)

(73) Assignee: Kudzu Arms, LLC, Hogansville, GA (US)

(21) Appl. No.: 18/188,155

(22) Filed: Mar. 22, 2023

Related U.S. Application Data
(60) Provisional application No. 63/325,761, filed on Mar. 31, 2022.

(51) Int. Cl. G08B 25/10; F41A 17/06; F41C 27/00

(52) U.S. Cl. CPC G08B 25/10; F41A 17/063; F41C 27/00

(57) ABSTRACT

Firearm monitoring systems having a sensor, a monitoring unit, a network, and a user device and/or an external device are disclosed. The firearm monitoring systems may be configured to detect gunfire via the sensor, collect gunfire data via the monitoring unit, and transmit the gunfire data to the network, user device, and/or external device.

### CROSS-REFERENCE TO RELATED APPLICATIONS

This application claims priority to and the benefit of U.S. Provisional Application No. 63/325,761, filed on Mar. 31, 2022, which is hereby incorporated by reference herein in its entirety.

### FIELD

The disclosure generally relates to firearms and more particularly relates to firearm monitoring platforms and systems.

### BACKGROUND

Military and law enforcement officers often encounter danger in the field. In the face of these regularly encountered dangers, officers must quickly and effectively communicate details of any attacks or hostile engagements. However, these officers are primarily focused on the conflict, and may not be able to effectively communication information related to the attack. These individuals will also relay information based solely on their perception of the conflict, which may not accurately reflect or convey the realities of the situation. It therefore may be difficult for individuals to ask for and receive support, provide status updates, or inform other units that an engagement or attack has commenced.

### SUMMARY

The disclosure generally relates to firearms and, more particularly, firearm monitoring platforms and systems. In aspects, a system for monitoring a firearm is provided, which includes a sensor configured to generate a first output if the sensor detects gunfire, and a monitoring unit operably coupled to the sensor. The monitoring includes a processor and a monitoring platform. The processor is configured to receive the first output from the sensor and generate a second output if the first output is received. The monitoring platform is configured to receive the second output from the processor. Upon receiving the second output from the processor, the monitoring platform initiates a data collection module to gather gunfire data, such as the time, location, angle, and/or direction of the gunfire.

In other aspects, a method for monitoring a firearm is provided. The method includes the steps of determining whether the firearm has been fired, communicating an output to a monitoring unit, initiating a data collection module of the monitoring unit, collecting information regarding the gunfire, and communicating the information to a user device or an external device.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Throughout the disclosure, depending on the context, singular and plural terminology may be used interchangeably.

FIG. 1 depicts a block diagram of the firearm monitoring system, in accordance with one or more embodiments of the disclosure.

FIG. 2 depicts a block diagram of the firearm monitoring system, in accordance with one or more embodiments of the disclosure.

FIG. 3 depicts a flow chart of the firearm monitoring system, in accordance with one or more embodiments of the disclosure.

FIG. 4A depicts a perspective view of the firearm monitoring system attached to a firearm, in accordance with one or more embodiments of the disclosure.

FIG. 4B depicts a side view of the firearm monitoring system attached to a firearm, in accordance with one or more embodiments of the disclosure.

FIG. 4C depicts a top view of the firearm monitoring system attached to a firearm, in accordance with one or more embodiments of the disclosure.

### DETAILED DESCRIPTION

The present disclosure describes firearm monitoring systems and methods capable of transmitting information concerning the discharge of a firearm in real-time. In aspects, the firearm monitoring systems and methods include a sensor and a monitoring unit. The sensor may detect parameters indicative of gunfire. The monitoring unit may collect data, such as the location and direction of the firearm, when discharge of the firearm is detected. In aspects, the firearm monitoring system may be installed on multiple firearms to increase the availability of information. This may be particularly beneficial when identifying the direction, or directions, of fire when multiple individuals, such as law enforcement officers or military personal, are involved in a hostile engagement.

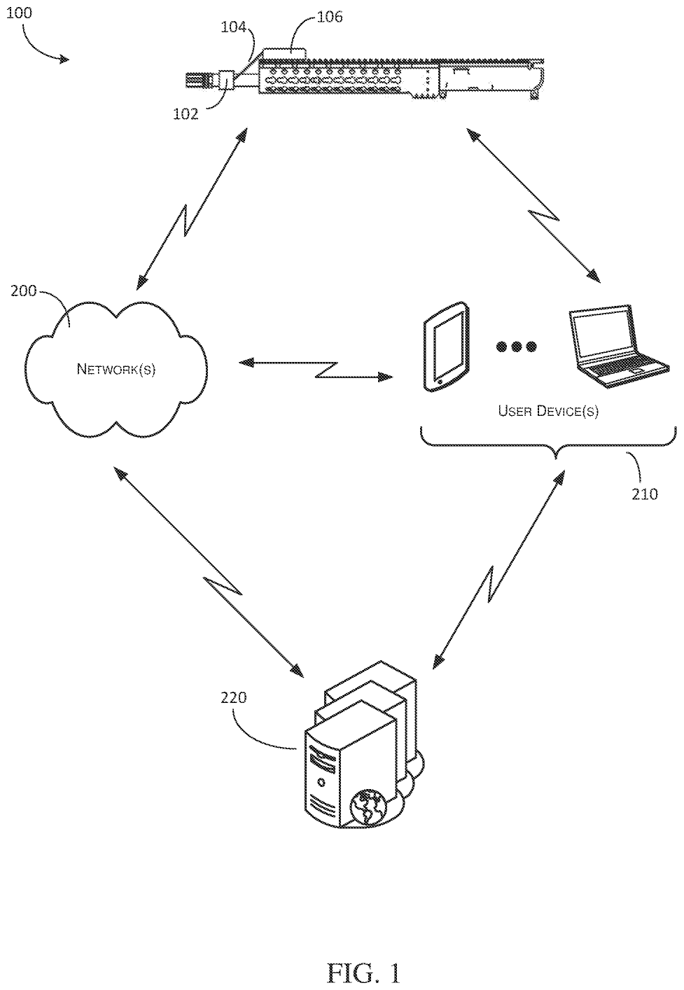

Referring to FIG. 1, an overview of an exemplary firearm monitoring system 100 is provided. The firearm monitoring system 100 includes a sensor 102 and a monitoring unit 106. In some instances, the sensor 102 and monitoring unit 106 may be attached to a firearm. For example, the sensor 102 may be attached to the barrel of the firearm (e.g., near the muzzle), and the monitoring unit 106 may be attached to the guard/handrail. The sensor 102 may be attached at any location on the firearm. In some instances, the sensor 102 and monitoring unit 106 may be a single unitary components. In other instances, the sensor 102 and monitoring unit 106 may be separate components in communication with each other. For example, the sensor 102 and monitoring unit 106 are operatively coupled via a wire 104. In other instances, the sensor 102 and monitoring unit 106 may wirelessly communicate with each other. The monitoring unit 106 is communicatively coupled to at least one user device 210 via a network 200. The monitoring unit 106 may include, at a minimum, a processor 108, memory, a communication system 110, and a power source 112. In some aspects, the user device 210 may be, for example, a mobile device, a wearable, a computer, a tablet, or the like.

The network 200 may include any one, or a combination of networks, such as a local area network (LAN), a wide area network (WAN), a telephone network, a cellular network, a cable network, a wireless network, and/or private/public networks, such as the Internet. For example, the network 200 may also support communication technologies, such as TCP/IP, Bluetooth, cellular, near-field communication (NFC), Wi-Fi, Wi-Fi direct, machine-to-machine communication, man-to-machine communication, and/or visible light communications.

The firearm monitoring system 100 may also include one or more external devices 220 (e.g., servers or the like). The one or more external devices 220 may also be communicatively coupled to the monitoring unit 106 via the network 200. In some aspects, the external device 220 may be a server that collects and stores data transmitted via the network. The data stored on the external device 220 may be accessible at any point. Data may be accessed and used, for example, in trainings or to resolve legal disputes.

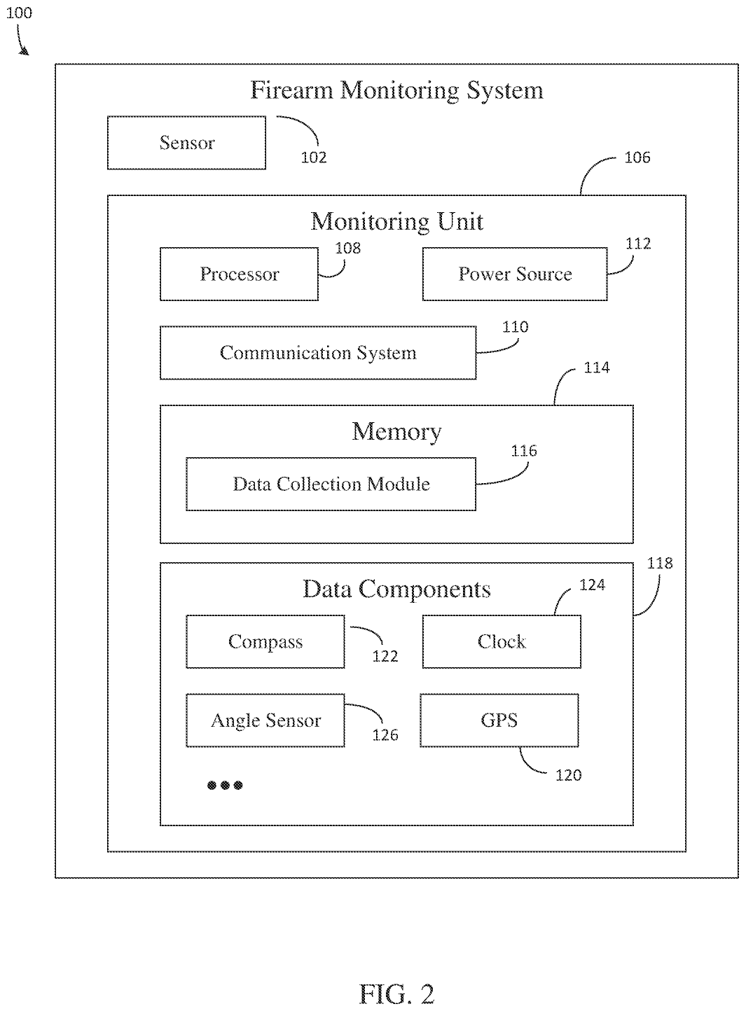

Referring now to FIG. 2, components that may be included in the firearm monitoring system 100 are described in further detail. The sensor 102 and the monitoring unit 106 are operable coupled via a wire 104. The sensor 102 may communicate an output to the monitoring unit 106 through the wire 104. Conversely, the monitoring unit 106 may transfer power to the sensor 102 through the wire 104. In some aspects, the sensor 102 may be powered independent of the monitoring unit 106.

The monitoring unit 106 may include one or more processors 108, a communication system 110, a power source 112, and a memory 114 configured to store a data collection module 116. The monitoring unit may also include a collection of data components 118. The data components 118 may include a global positioning system (GPS) 120, compass 122, clock 124, and angle sensor 124.

The communication system 110 may include a wireless transceiver that allows the monitoring unit 106 to communicate with the sensor 102 and/or the user device 120. The wireless transceiver may use any of various communication formats, including Internet, Bluetooth, or cellular formats. The power source 112 provides power to the electrical components of the monitoring unit 106, and may include a primary cell or battery, a secondary (rechargeable) cell or battery, or a combination of both.

The memory 114, which is one example of a non-transitory computer-readable medium may be used to perform the stored data collection module 116. The data collection module 116 is provided in the form of computer-executable instructions that may be executed by the processor 108 to perform various operations in accordance with the disclosure.

The memory 114 may include a single memory element or any combination of volatile memory elements (e.g., random access memory (RAM, such as DRAM, SRAM, SDRAM, etc.)) and non-volatile memory elements (e.g., ROM, hard drive, tap, CDROM, etc.). Moreover, the memory 114 may incorporate electronic, magnetic, optical, and/or other types of storage media. In the context of this disclosure, a “non-transitory computer-readable medium” can be, for example but not limited to, an electronic, magnetic, optical, electromagnetic, infrared, or semiconductor system, apparatus, or device. More specific examples of a computer-readable medium would include a portable computer diskette (magnetic), a random-access memory (RAM) (electronic), a read-only memory (CD ROM) (optical). The computer-readable medium could even be paper, or another suitable medium upon which the program is printed, since the program can be electronically captured, for example, via optical scanning of the paper or other medium, then compiled, interpreted, or otherwise processed in a suitable manner if necessary, and then stored in a computer memory.

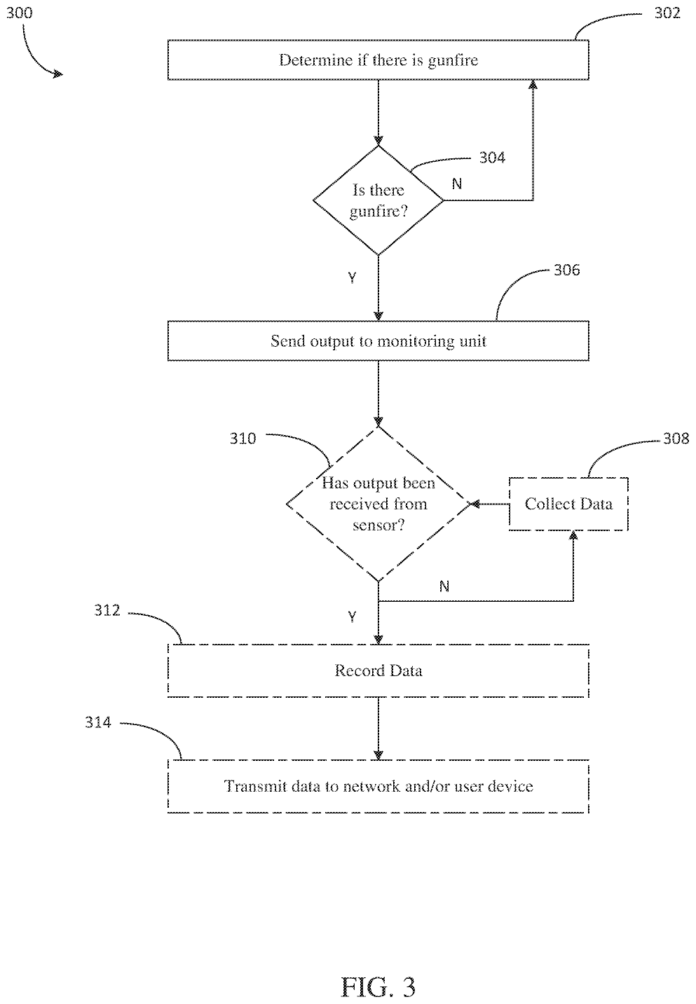

Referring now to FIG. 3, an exemplary method 300 for monitoring use of a firearm is described. The sensor 102 is configured to determine whether the firearm to which it is attached has been discharged (302). The sensor 102 may be a pressure, photo, audio, LIDAR, radar, speed, strain, vibration, camera, direction, GPS, and/or motion sensor. The sensor 102 may be any suitable sensor. The sensor 102 may also be configured to detect recoil or vibrations from the firearm, indicative of discharge. It would be understood that the sensor 102 may be configured to detect discharge according to any means known to one of ordinary skill. The aforementioned sensors 102 may be used alone, or in any combination.

If the sensor 102 detects discharge of the firearm 304, the sensor 102 will communicate an output 306 to the monitoring unit 106 via the wire 104. While the monitoring unit 106 is waiting for the output from the sensor 102, the monitoring unit 106 is continuously collecting data 308 from the data components 118. The data produced by these components 118 is readily available for processing when the monitoring unit 106 receives the output from the sensor 102.

When the output is received 310, the data collection module 116 is initiated. The data collection module 116 instructs the processor 108 to collect and record the information from the data components 118 corresponding to the output 312. The data collection module 116 may gather information related to, for example, the time the gun was fired from the clock 124 and the location of the fire from the GPS 120. The data collection module 116 may also gather information pertaining to the angle/direction of fire from the compass 122 and angle sensor 126. This data is then communicated to the user device 210 and/or external device 220 via the network 200.

The user device(s) 210 may be monitored by military or law enforcement agencies while officers are engaged in conflict in the field. In some aspects, the data may inform those monitoring the user device 210 that an anticipated conflict has begun. In other aspects, the data may inform those monitoring the user device 210 of an unanticipated conflict, in which case backup or support may be provided.

In aspects, an additional user device 210 may be linked to the monitoring system 100 and activated upon receiving a signal from the monitoring unit 106 that gunfire has ensued. In some aspects, the additional user device 210 is, for example, a video recording device, an audio recording device, or a GPS positioning device for collecting additional information regarding the situation surround the gunfire. In some aspects, this video, audio, or satellite information may be transmitted to military or law enforcement agencies along with the data collected directing from the monitoring unit 106.

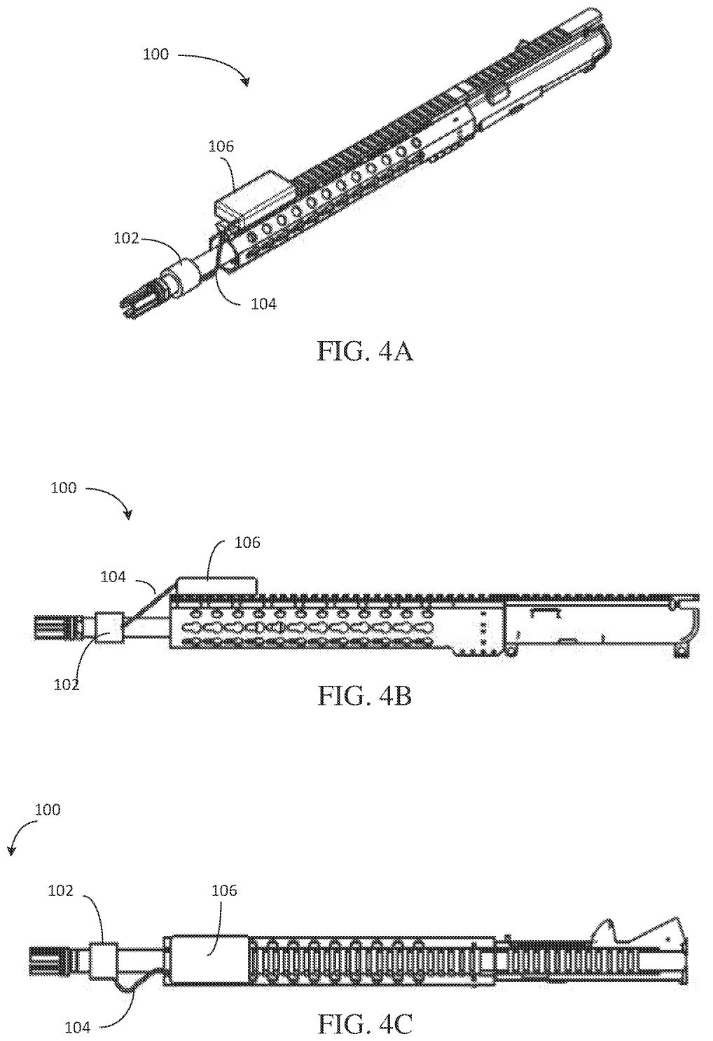

Referring now to FIGS. 4A-4C, the firearm monitoring assembly 100, attached to a firearm, is shown according to an exemplary embodiment. The sensor 102 and the monitoring unit 106 are secured to the firearm. In some aspects, the sensor 102 may be attached to the barrel of the firearm and the monitoring unit 106 may be attached to the base of the firearm. The sensor 102 and the monitoring unit 106 are attached to the firearm in close proximity, such that the sensor 102 and monitoring unit 106 can be connected by the wire 104. In other aspects, the sensor 102 and the monitoring unit 106 may be attached to the barrel of the firearm. In even further aspects, the sensor 102 and the monitoring unit 106 may be attached to the base of the firearm.

In aspects, the sensor 102 and the monitoring unit 106 may be fixed to a firearm such that the sensor 102 and monitoring unit 106 cannot be moved by the user. In other aspects, a firearm may have a series of attachment points so that the sensor 102 and monitoring unit 106 can be moved and/or adjusted as necessary to fit a user's preferences. In further aspects, the sensor 102 and monitoring system 106 may be added to already manufactured firearms. Alternatively, new firearms may be produced with the sensor 102 and monitoring unit 106 already attached.

In aspects, the sensor 102 is cylindrical. The sensor 102 has a central lumen that is at least large enough to receive the barrel of a firearm. In other aspects, the sensor 102 may not be cylindrical, while still performing the functions previously described. The sensor 102 may also be any size, however the sensor 102 cannot be so large that it interferes with the user's line of sight or shooting.

In aspects, the monitoring unit 106 is rectangular. In other aspects, the monitoring unit 106 may be any other shape, while still performing the functions previously described. Similar to the sensor 102, the monitoring unit 106 may be any size so long as the size does not interfere with use of the firearm.

The sensor 102 and monitoring unit 106 may be contained within a housing. In some aspects, the housing includes a sensor portion and a monitoring unit portion. The housing, therefore, may be attached to the barrel and the base of the firearm. In other aspects, the enclosure includes a single compartment to house the sensor 102 and monitoring unit 106. The housing, therefore, may be attached either to the barrel or the base of the firearm.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Conditional language, such as, among others, “can,” “could,” “might,” or “may,” unless specifically stated otherwise, or otherwise understood within the context as used, is generally intended to convey that certain embodiments could include, while other embodiments may not include, certain features, elements, or steps. Thus, such conditional language is not generally intended to imply that features, elements, or steps are in any way required for one or more embodiments.

That which is claimed is:

1. A system for monitoring a firearm, the system comprising:
a sensor configured to generate a first output if the sensor detects gunfire; and
a monitoring unit operably coupled to the sensor, the monitoring unit comprising:
a processor configured to receive the first output from the sensor and generate a second output if the first output is received; and
a monitoring platform configured to receive the second output from the processor.

2. The system of claim 1, wherein the sensor is a pressure sensor, a photo sensor, an audio sensor, a LIDAR sensor, a radar sensor, a speed sensor, a strain sensor, a vibration sensor, a camera sensor, a direction sensor, a GPS sensor, and/or a motion sensor.

3. The system of claim 1, wherein the sensor is configured to detect a recoil or a vibration from the firearm indicative of a discharge of the firearm.

4. The system of claim 1, wherein the monitoring unit further comprises at least one data collection component, such as a global positioning system, a compass, a clock, or an angle sensor.

5. The system of claim 1, wherein the sensor and the monitoring unit are contained within a single housing.

6. The system of claim 1, wherein the sensor is contained within a sensor housing, and wherein the monitoring unit is contained within a monitoring unit housing.

7. The system of claim 6, wherein the sensor housing is removably attachable to a barrel of the firearm.

8. The system of claim 6, wherein the sensor housing is removably attachable to a base of the firearm.

9. The system of claim 1, wherein the sensor and the monitoring unit are operatively coupled via a wire.

10. The system of claim 10, wherein the sensor and the monitoring unit are operatively coupled via a wireless connection.

11. The system of claim 1, wherein, upon receiving the second output from the processor, the monitoring platform is configured to initiate a data collection module.

12. The system of claim 11, wherein the data collection module is configured to gather gunfire data, such as the time, location, angle, and/or direction of the gunfire.

13. The system of claim 12, further comprising a network, a user device, and an external device, wherein each of the network, the user device, and the external device are operatively coupled to monitoring unit.

14. The system of claim 13, wherein the network, the user device, and the external device are configured to receive the gunfire data from the monitoring device.

15. A method for monitoring a firearm, the method comprising:
determining whether the firearm has been fired;
communicating an output to a monitoring unit;
initiating a data collection module of the monitoring unit;
collecting information regarding the gunfire; and
communicating the information to a user device and/or an external device.

16. The method of claim 15, wherein the monitoring unit and the user device and/or the external device are operatively coupled via a network.

17. The method of claim 16, wherein the network is a local area network (LAN), a wide area network (WAN), a telephone network, a cellular network, a cable network, a wireless, network, a private or public network such as the Internet, or a combination thereof.

18. The method of claim 15, wherein the user device is a mobile device, a computer, or a tablet configured to display the information to a user.

19. The method of claim 15, wherein the external device is a server configured to store the information.

20. A firearm monitoring system configured to perform the method of claim 15.
